(19) United States
(12) Patent Application Publication
(10) Pub. No.: US 2012/0011101 A1
(43) Pub. Date: Jan. 12, 2012

(54) INTEGRATING CLIENT AND SERVER DEDUPLICATION SYSTEMS

(75) Inventors: Zhenqiu Fang, Beijing (CN); Taiwen Zhang, Beijing (CN); Kai Zhang, Beijing (CN); Ming Yan, Beijing (CN); Liqiu Song, Biejing (CN)

(73) Assignee: COMPUTER ASSOCIATES THINK, INC., Islandia, NY (US)

(21) Appl. No.: 12/834,616

(22) Filed: Jul. 12, 2010

(51) Int. Cl. G06F 17/30; G06F 15/16; H04L 9/00

(52) U.S. Cl. 707/654; 713/189; 707/E17.005

(57) ABSTRACT

According to one embodiment of the present invention, a method for integrating client and server deduplication systems may be provided. In this method, a first hash set of a previous backup session may be received from a server. The first hash set may comprise a plurality of cryptographic values generated using a plurality of data blocks of a first data set of a client. A second hash set may be generated using a plurality of data blocks of a second data set of the client. A deduplicated data set may be generated by the client according to the first hash set and the second hash set and may comprise a plurality of non-redundant data blocks of the second data set. The second hash set and the deduplicated data set may be transmitted to the server.

### TECHNICAL FIELD

This invention relates generally to the field of data backup and more specifically to integrating client and server deduplication systems.

### BACKGROUND

Data compression may be used in a data backup system to reduce the amount of storage required for data backup. Deduplication is a form of data compression that reduces redundant data storage.

### SUMMARY OF THE DISCLOSURE

In accordance with the present invention, disadvantages and problems associated with previous techniques for data deduplication may be reduced or eliminated.

According to one embodiment of the present invention, a method for integrating client and server deduplication systems may be provided. In this method, a first hash set of a previous backup session may be received from a server. The first hash set may comprise a plurality of cryptographic values generated using a plurality of data blocks of a first data set of a client. A second hash set may be generated using a plurality of data blocks of a second data set of the client. A deduplicated data set may be generated by the client according to the first hash set and the second hash set and may comprise a plurality of non-redundant data blocks of the second data set. The second hash set and the deduplicated data set may be transmitted to the server.

Certain embodiments of the invention may provide one or more technical advantages. A technical advantage of one embodiment may be that deduplication may be performed at a client or a server. Another technical advantage of one embodiment may be that utilization of backup system resources is enhanced.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 depicts an embodiment of an integrated data deduplication system;

FIG. 2 depicts an example of data deduplication performed at a backup destination;

FIG. 3 depicts an example flow of data deduplication; and

FIG. 4 depicts an example of data deduplication performed at a backup source.

### DETAILED DESCRIPTION OF THE DRAWINGS

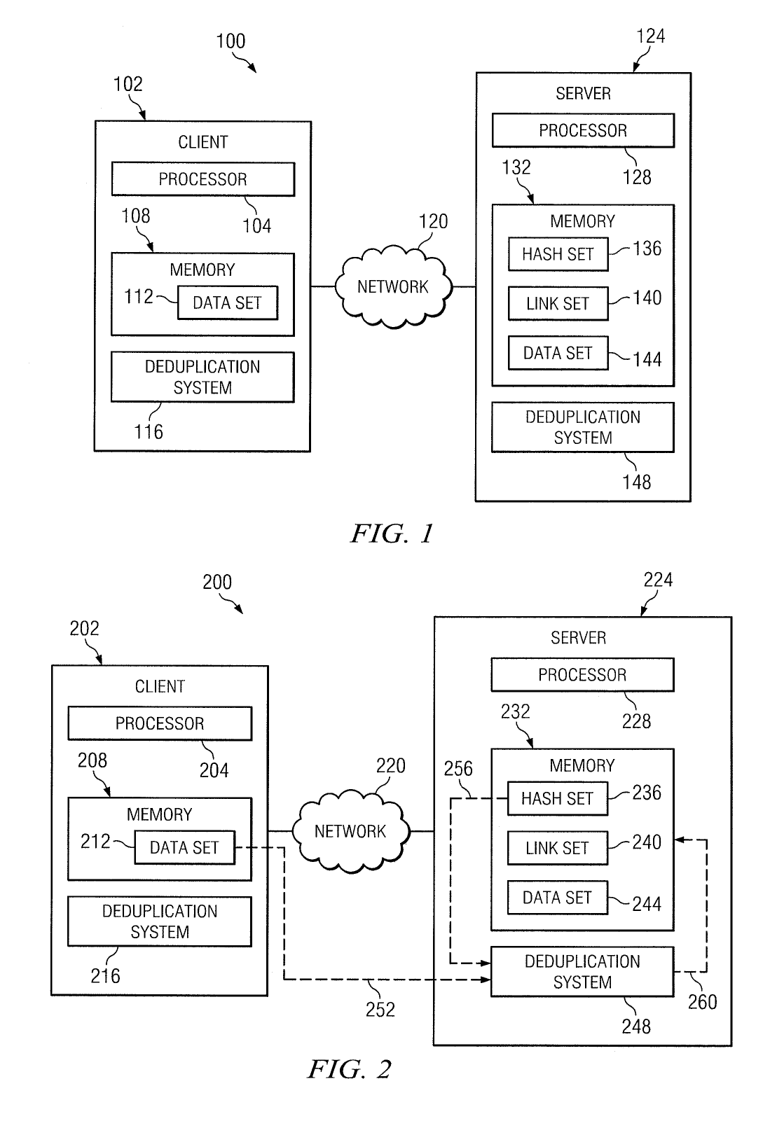

Embodiments of the present invention and its advantages are best understood by referring to FIGS. 1-4 of the drawings, like numerals being used for like and corresponding parts of the various drawings.

Data compression is the process of encoding information such that the encoded information uses less memory than the unencoded information. Data compression may improve data backup performance. For example, data compression can reduce the amount of memory required at the backup destination. Data compression can also reduce the amount of data that is sent between the backup source and the backup destination and thus uses less bandwidth between the backup source and destination.

In certain embodiments, deduplication is a form of data compression that reduces repetitive backup of data. During deduplication, a hash function may be run on each block of data marked for backup. The hash function produces a unique cryptographic value, such as a hash value, for the data block. The amount of memory required to store a cryptographic value is generally much smaller than that required to store the corresponding data block. In certain embodiments, the cryptographic values may be compared to identify repetitive data blocks. The unique data blocks are stored at the backup destination and links to the unique data blocks are generated. During a data restore operation, the links and the unique data blocks allow restoration of the data to its original format. The cryptographic values may be saved for use in future backup sessions.

Deduplication software may reside at a backup destination or a backup source. In general, the backup destination and backup source are computers capable of transferring and storing data. For example, the backup destination may be a server and the backup source may be a client, such as a product server. Performing deduplication at the backup destination frees up resources at the backup source, but requires the backup source to send all of the backup data, including repetitive data, over a connection, such as a network, between the backup source and the backup destination. This may be problematic in bandwidth limited connections. Conversely, when data is deduplicated at the backup source, only the non-repetitive data is sent across the connection for backup. However, deduplication at the backup source requires memory and processing resources of the backup source, and thus can negatively affect applications running on the backup source. Overall backup performance can be improved by allowing a user to choose the data deduplication site before each backup session.

FIG. 1 depicts an embodiment of an integrated data deduplication system 100. This system allows a user to select either a backup source or a backup destination as the deduplication site. The user may switch between the deduplication sites based on available resources of the system. In general, a user may select a deduplication site from a dialog box, the selection may be automatic based on resource availability, or any other suitable method of selection may be used. The system 100 is operable to integrate deduplication operations performed at both sites and store the results at the backup destination. Such a system enables efficient use of resources of the backup source, backup destination, and network.

The system 100 may comprise a backup source, such as client 102, a backup destination, such as server 124, and a connection, such as network 120. Client 102 may comprise one or more processors 104, a memory 108, and a deduplication system 116. Memory 108 may comprise data set 112. Data set 112 comprises data of the client 102 that is backed up on server 124 over network 120. Data set 112 may comprise a plurality of data blocks. In general, these data blocks may be individual files, portions of files, file sets, directories, other suitable units of data, other suitable units of data, and/or any combination of any of the preceding. Memory 108 may also comprise data this is not marked for backup (not expressly shown).

In general, network 120 may be a wired connection, a wireless connection, or combinations thereof. Network 120 is operable to allow data transmission between client 102 and server 124, and need not be a direct connection. For example, backup data may pass through one or more nodes of network 120 as it travels between client 102 and server 124.

Server 124 may comprise one or more processors 128, a memory 132, and a deduplication system 148. Memory 132 may comprise a hash set 136, a link set 140, and a data set 144. A hash set is a collection of hash values, a link set is a collection of links that correspond to hash values and identify locations of data blocks, and a data set is a collection of data blocks. Backup session results, including hash values, links, and data blocks, may be stored in memory 132. Memory 132 may store results from a plurality of backup sessions. These results may be stored separately by session or multiple sessions may be merged. Memories 108 and 132 may also include storage for applications running on client 102 or server 124 (not expressly shown).

The client 102 and the server 124 may respectively comprise deduplication systems 116 and 148. The deduplication systems may comprise logic that, when executed, is operable to deduplicate a data set. The deduplication systems may respectively access memories 108 and 132 to read data and write results and may utilize one or more processors 104 and 128 to perform deduplication operations.

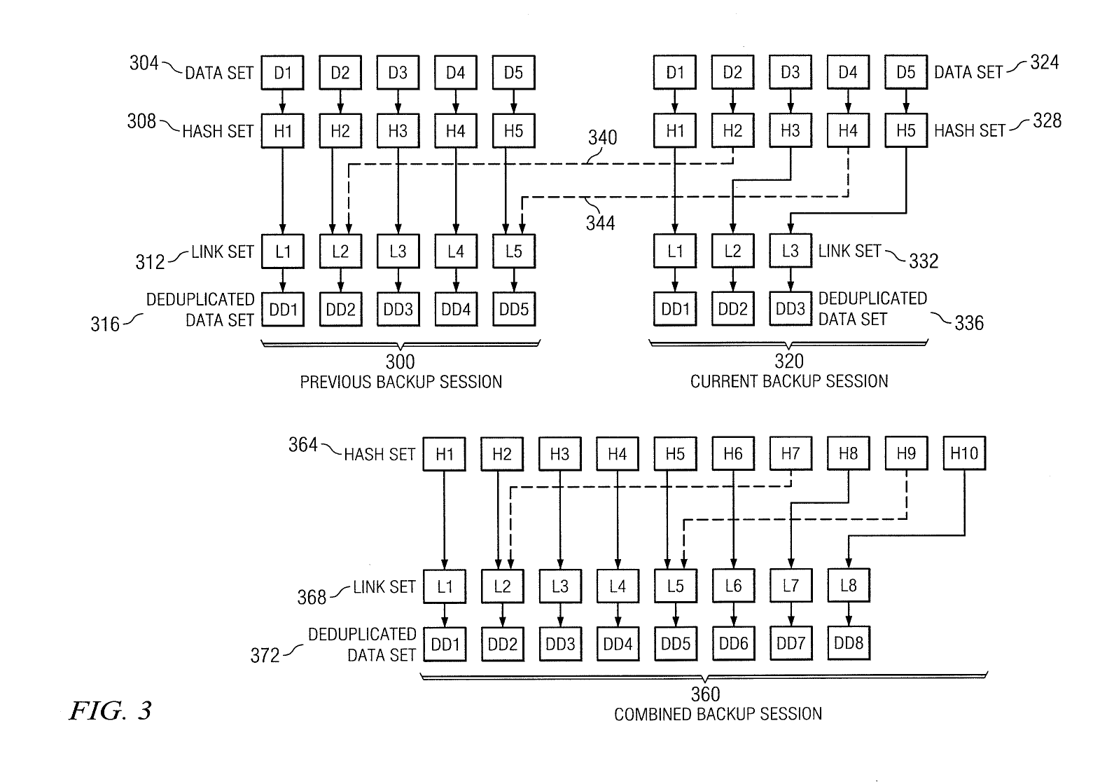

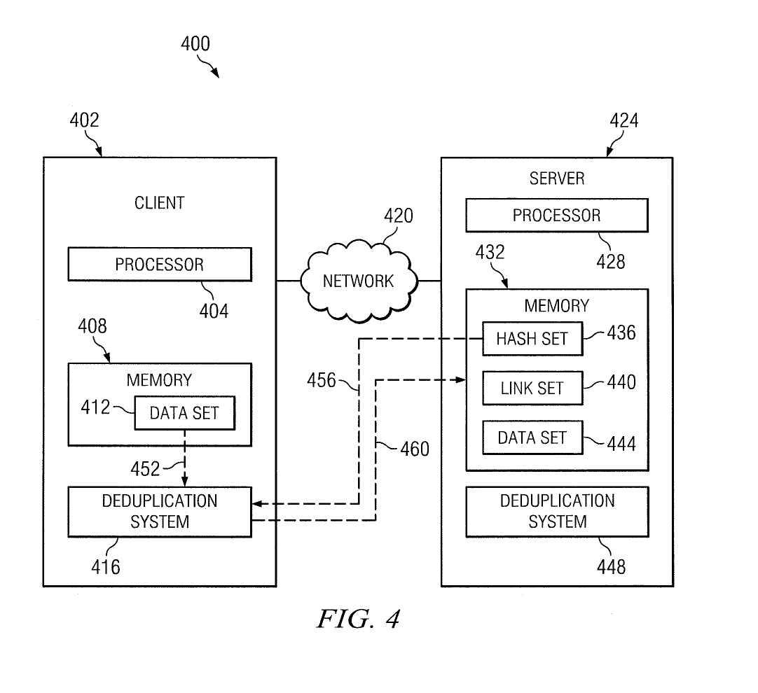

FIG. 2 depicts data deduplication performed at the server of an integrated data deduplication system 200 and FIG. 3 depicts an example flow of data deduplication. The flow includes previous backup session 300, current backup session 320, and a resulting combined backup session 360. The data deduplication depicted in FIG. 3 may also be performed at a backup source, as described below in conjunction with FIG. 4.

In previous backup session 300, data set 304 may comprise five unique data blocks, D1 through D5. Data set 304 may comprise data blocks of data set 212 sent over network 220 from client 202 for backup on server 224. These data blocks may be used to generate a plurality of cryptographic values. For example, a cryptographic value, such as a hash value, may be generated for each of these data blocks. In such an embodiment, a hash function may be performed on the content of the data block to generate a hash value of the data block. The amount of memory required to store a hash value of the data block is generally much smaller than that required to store the data block itself. The resulting hash values are stored in hash set 308, depicted as H1 through H5.

In the example of FIG. 3, each data block of data set 304 is non-redundant, that is, each data block is unique with respect to the other data blocks of data set 304. Accordingly, each hash value of hash set 308 is unique. A link is generated for each hash value. A link identifies the location of the contents of a data block that was used to generate the corresponding hash value. In an embodiment, a link may be a pointer to the location of a deduplicated data block. In FIG. 3, links L1 through L5 of link set 312 identify the locations of deduplicated data blocks DD1 through DD5 of deduplicated data set 316. Deduplicated data block DD1 comprises the content of D1, DD2 comprises the content of D2, and so on. A deduplicated data set comprises deduplicated data blocks, that is, the unique data blocks of a data set. A deduplicated data block can be formed from the corresponding data block, that is, by copying the contents of the data block to a new location, or it can be the corresponding data block itself.

The results of a backup session may be written to memory 232 of server 224, as shown by dotted line 260. For example, the results of the previous backup session 300 may be written to memory 232. In an embodiment, the hash values may be recorded in hash set 236, the links may be recorded in link set 240, and the deduplicated data may be recorded in data set 244. The client 202 may subsequently send another data set 324 from data set 212 over network 220 for backup at the server in a current backup session 320, as shown by dotted line 252.

In the current backup session, data set 324 comprises five data blocks, D1 through D5. Each of these data blocks is non-redundant, that is, each data block is unique with respect to the other data blocks of data set 324. Thus, five unique hash values H1 through H5 may be generated from the data blocks of data set 324. A deduplicated data set may be generated according to the hash values of the previous backup session and the hash values of the current backup session. For example, a hash value of a data block may be compared to the hash values of the previous backup session and the other hash values of the current backup session to determine whether a data block is unique. If the data block is not unique, it does not need to be stored on server 224, rather, a link to a copy of the equivalent data is sufficient.

In an embodiment, hash values from one or more earlier backup sessions, such as hash set 308, may be obtained from memory 232, as shown by dotted line 256. Each of the hash values H1 through H5 of the current backup session may be selected. If the selected hash value is not equivalent to any hash value H1 through H5 of the previous backup session or a hash value that has already been selected in the current backup session, then a deduplicated data block is formed comprising the contents of the data block used to generate the selected hash value. A link that identifies the location of the deduplicated data block is associated with the selected hash value. Conversely, if a selected hash value is equivalent to a hash value of the previous backup session or a hash value of the current backup session that has already been selected, a deduplicated data block is not created. Rather, the hash value is associated with the existing link that identifies the location of the equivalent data block.

For example, if the hash value H2 of the current backup session 320 is equivalent to the hash value H2 of the previous backup session 300, then the data block D2 of the current backup session 320 is equivalent to data block D2 of the previous backup session 300 and does not need to be backed up again. Accordingly, the link associated with H2 of the current backup session 320 is L2 of link set 312 of the previous backup session 300 as shown by dotted line 340. Similarly, H4 of current backup session 320 is equivalent to H5 of previous backup session 300, so L5 of the previous backup session 300 is associated with H4 of the current backup session. Since H1, H3, and H5 of the current backup session are not equivalent with any other hash value of the previous backup session or the current backup session, new links are generated for these hash values, the links identifying deduplicated data blocks DD1, DD2, and DD3 of deduplicated data set 336.

After the hash values of the current backup session are associated with links, the deduplicated data set of the current backup session comprises a set of non-redundant data blocks that are distinct from the data blocks of the previous backup session stored in data set 244. The deduplicated data set, the hash set, and the link set of the current backup session are recorded in memory 232. This information may be merged with the results of one or more earlier backup sessions stored in memory 232.

For example, the previous backup session 300 and current backup session 320 may be merged to form combined backup session 360. Combined backup session 360 includes hash set 364 comprising the hash values of the previous backup session merged with the hash values of the current backup session. Combined hash set 364 could be used in a future backup session to allow identification of data blocks not already included in deduplicated data set 372. In some embodiments, the hash set of the combined backup session 360 comprises unique hash values. For example, because H7 and H9 of combined backup session 360 are equivalent to H2 and H5 respectively, H7 and H9 may be omitted from a hash set used in a future backup session. In some embodiments, only the unique hash values are stored in memory at the server. Combined backup session 360 also includes link set 368 comprising the links generated in the previous backup session and the current backup session. The combined backup session 360 also comprises deduplicated data set 372 comprising the merged deduplicated data sets of the two backup sessions, deduplicated data blocks DD1 through DDB. These deduplicated data blocks represent the unique data blocks of previous backup session 300 and current backup session 320.

As explained above, in an embodiment, the deduplication site may be selected by a user and/or logic, and the deduplication results from the selected site can be integrated with previous results and stored at the backup destination. In general, the selection of the deduplication site may be based on a number of factors such as the utilization of one or more processors of the backup source, the amount of memory available at the backup source, and/or the available bandwidth over a network that connects the backup source and the backup destination. For example, if the available bandwidth over the network is low, a backup source may be selected for deduplication in order to minimize the backup data sent over the network. Conversely, if available bandwidth over the network is sufficient, the backup source may send the data set to the server for deduplication at the backup destination. As another example, if one or more processors or memory of the backup source is required by other applications of the backup source, the backup destination may be selected as the deduplication site in order to avoid negatively impacting these applications.

FIG. 4 depicts an example of data deduplication performed at the backup source. In such a configuration, blocks of data from data set 412 may be sent to deduplication system 416, as shown by dotted line 460. As shown by dotted line 456, hash values of one or more previous backup sessions stored in hash set 436 may be sent over network 420 to client 402. For example, the combined hash set 364 of FIG. 3 may be used. A hash value for each data block of data set 412 is generated by deduplication system 116. These hash values are compared with each other and the hash values sent from hash set 436 to identify data blocks of data set 412 that are non-redundant to each other and distinct from the data blocks of data set 444 that correspond to the hash values sent from hash set 436. Links to unique data blocks are generated and associated with the hash values. As shown by dotted line 460, the results of the deduplication may be sent over network 420 to server 424. For example, the newly generated hash values, links, and deduplicated data blocks may be sent to server 424 for storage. As described above, this data may be merged with data of previous backup sessions and/or used in future backup sessions. In addition to the operations described above, the deduplication system of the client may perform any of the operations of the deduplication system of the server, as described above.

In order to integrate and reuse results from multiple backup sessions, the deduplication systems of the backup source and the backup destination may have common input and output formats. Alternatively, the system could comprise one or more translating modules to allow backup results from one deduplication system to be read as input by the other and/or to translate results into a common format to allow merging of results.

Modifications, additions, or omissions may be made to the systems and apparatuses disclosed herein without departing from the scope of the invention. The components of the systems and apparatuses may be integrated or separated. For example, the hash set, link set, and data set of server 124 may be combined in a single file. Moreover, the operations of the systems and apparatuses may be performed by more, fewer, or other components. For example, the operations of deduplication systems 116 and 148 may be performed by more than one component. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The method may include more, fewer, or other steps.

A component of the systems and apparatuses disclosed herein may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method for integrating client and server deduplication systems, comprising:
receiving, from a server, a first hash set of a previous backup session, the first hash set comprising a plurality of cryptographic values generated using a plurality of data blocks of a first data set of a client;
generating a second hash set using a plurality of data blocks of a second data set of the client, the second hash set comprising a second plurality of cryptographic values;
generating, by the client, a deduplicated data set according to the first hash set and the second hash set, the deduplicated data set comprising a plurality of non-redundant data blocks of the second data set; and
transmitting the second hash set and the deduplicated data set to the server, the server operable to merge the second hash set with the first hash set for a future backup session.

2. The method of claim 1, the previous backup session comprising generating, by the server, an initial deduplicated data set comprising a plurality of non-redundant data blocks of the first data set.

3. The method of claim 1, each data block of the plurality of non-redundant data blocks of the second data set distinct from each data block of a plurality of data blocks of an initial deduplicated data set of the previous backup session.

4. The method of claim 1, the server further operable to merge the deduplicated data set with an initial deduplicated data set of the previous backup session.

5. The method of claim 1, further comprising:
selecting either the client or the server to generate a second deduplicated data set, the selecting based on at least one of a utilization of a processor of the client, a utilization of a memory of the client, and an available bandwidth from the client to the server.

6. The method of claim 1, the server further operable to generate a second deduplicated data set according to the first hash set, the second hash set, and a third data set of the client, the second deduplicated data set comprising a plurality of non-redundant data blocks not included in the first deduplicated data set.

7. The method of claim 1, further comprising:
generating a plurality of links according to the first hash set and the second hash set, each link corresponding to a hash value of the second hash set, each link identifying the location of a data block corresponding to the hash value.

8. The method of claim 1, the first hash set of the previous backup session comprising a plurality of hash values of a plurality of backup sessions.

9. An apparatus comprising:
a memory operable to:
store a first hash set of a previous backup session, the first hash set generated by a server, the first hash set comprising a plurality of cryptographic values generated using a plurality of data blocks of a first data set of a client; and
a processor operable to:
generate a second hash set using a plurality of data blocks of a second data set of the client, the second hash set comprising a second plurality of cryptographic values;
generate a deduplicated data set according to the first hash set and the second hash set, the deduplicated data set comprising a plurality of non-redundant data blocks of the second data set; and
transmit the second hash set and the deduplicated data set to the server, the server operable to merge the second hash set with the first hash set for a future backup session.

10. The apparatus of claim 9, the previous backup session comprising generating, by the server, an initial deduplicated data set comprising a plurality of non-redundant data blocks of the first data set.

11. The apparatus of claim 9, each data block of the plurality of non-redundant data blocks of the second data set distinct from each data block of a plurality of data blocks of an initial deduplicated data set of the previous backup session.

12. The apparatus of claim 9, the server further operable to merge the deduplicated data set with an initial deduplicated data set of the previous backup session.

13. The apparatus of claim 9, the processor further operable to:
select either the client or the server to generate a second deduplicated data set, the selecting based on at least one of a utilization of a processor of the client, a utilization of a memory of the client, and an available bandwidth from the client to the server.

14. The apparatus of claim 9, the server further operable to generate a second deduplicated data set according to the first hash set, the second hash set, and a third data set of the client, the second deduplicated data set comprising a plurality of non-redundant data blocks not included in the first deduplicated data set.

15. The apparatus of claim 9, the processor further operable to:
generate a plurality of links according to the first hash set and the second hash set, each link corresponding to a hash value of the second hash set, each link identifying the location of a data block corresponding to the hash value.

16. The apparatus of claim 9, the first hash set of the previous backup session comprising a plurality of hash values of a plurality of backup sessions.

17. A method for integrating client and server deduplication systems, comprising:
generating, at a server, a first hash set and a first deduplicated data set, the first hash set comprising a plurality of cryptographic values generated using a plurality of data blocks of a first data set of a client, the first deduplicated data set comprising a plurality of non-redundant data blocks of the first data set; and
receiving, at the server, a second hash set and a second deduplicated data set, the second hash set comprising a plurality of cryptographic values generated using a plurality of data blocks of a second data set of the client, the second deduplicated data set generated, by the client, according to the first hash set and the second hash set, the second deduplicated data set comprising a plurality of non-redundant data blocks of the second data set of the client.

18. The method of claim 17, further comprising:
merging the second hash set with the first hash set for a future backup session.

19. The method of claim 17, each data block of the second deduplicated data set distinct from each data block of the first deduplicated data set.

20. The method of claim 17, further comprising:
merging the second deduplicated data set with the first deduplicated data set.

21. The method of claim 17, further comprising:
selecting either the client or the server to generate a third deduplicated data set, the selecting based on at least one of a utilization of a processor of the client, a utilization of a memory of the client, and an available bandwidth from the client to the server.

22. The method of claim 17, further comprising:
generating a third deduplicated data set according to the first hash set, the second hash set, and a third data set of the client, the third deduplicated data set comprising a plurality of non-redundant data blocks not included in a combined data set comprising the first deduplicated data set and the second deduplicated data set.

23. The method of claim 17, further comprising:
generating a plurality of links according to the first hash set and the second hash set, each link corresponding to a hash value of the second hash set, each link identifying the location of a data block corresponding to the hash value.
